(19) United States
(12) Patent Application Publication
(10) Pub. No.: US 2013/0192861 A1
(43) Pub. Date: Aug. 1, 2013

(54) HAND POWER TOOL DEVICE

(71) Applicant: Willy Braun, Neustetten (DE)

(72) Inventor: Willy Braun, Neustetten (DE)

(73) Assignee: Robert Bosch GmbH, Stuttgart (DE)

(21) Appl. No.: 13/642,197

(22) PCT Filed: Apr. 18, 2011
(86) PCT No.: PCT/EP2011/056077

§ 371 Date: Jan. 8, 2013

(30) Foreign Application Priority Data
Apr. 20, 2010 (DE) 10 2010 027 941.2
Apr. 14, 2011 (DE) 10 2011 007 433.3

(51) Int. Cl. B25D 17/24

(52) U.S. Cl. CPC B25D 17/24
USPC 173/162.2

(57) ABSTRACT

A hand power tool device includes a hammer tube and a B-impact damping system. The B-impact damping system includes at least one damping mechanism configured to damp recoil energy. The damping mechanism is disposed at least partially radially outside of the hammer tube in at least one operating state.

### PRIOR ART

The invention is based on a hand power tool device as claimed in the preamble of claim 1.

A hand power tool device has already been proposed in EP 1 992 453 A1, in particular for a rotary and/or chipping hammer, having a hammer tube and a B-impact damping system comprising at least one damping means that is provided to damp recoil energy.

### DISCLOSURE OF THE INVENTION

The invention is based on a hand power tool device having a hammer tube and a B-impact damping system comprising at least one damping means that is provided to damp a recoil energy.

It is proposed that, in at least one operating state, the damping means is disposed at least partially radially outside of the hammer tube. A “hammer tube” is to be understood to be, in particular, a means provided to mount a striker such that it is movable in a main working direction. Preferably, a working air pressure that, in at least one operating state, accelerates the striker can be built up inside the hammer tube in at least one operating state. The term “striker” is to be understood to mean, in particular, a means that is accelerated by the working air pressure during impact operation and that delivers an impact impulse to an insert tool in the main working direction. Preferably, a piston generates the working air pressure. The term “main working direction” is to be understood to mean, in particular, a direction in which an operator moves the rotary hammer during a working motion in the provided manner. Preferably, the main working direction is aligned parallelwise in relation to an impact direction of the striker. “Provided” is to be understood to mean, in particular, specially equipped and/or designed. In particular, a “B-impact damping system” is to be understood to be a device provided to transfer a recoil energy in a damped manner, at least partially, to a hand power tool housing. In particular, a “recoil energy” is to be understood to be an energy that, when an insert tool impacts upon a workpiece, is reflected by the workpiece in the direction of the insert tool. Preferably, the recoil energy accelerates an impact means of the hand power tool device contrary to the impact direction. Preferably, the B-impact damping system is provided to effect damped braking of the motion caused by the recoil energy of the impact means. Preferably, the recoil energy is carried by a compressive stress wave. “Damping” in this context is to be understood to mean, in particular, that the B-impact damping system reduces an amplitude of a recoil force through friction and/or elastic deformation of the damping means. A “damping means” is to be understood to be, in particular, a means realized so as to be deformable by the recoil energy by at least 10%, advantageously at least 25%, of a length in the direction of loading. Alternatively and/or additionally, through friction, by means of a specially realized surface, the damping means could convert a part of the recoil energy into thermal energy. In particular, at least 25%, advantageously at least 50%, particularly advantageously at least 75%, of the recoil energy acts upon the damping means during operation. Preferably, the damping means is constituted at least partially by an elastic material such as, for example, an elastomer material. Alternatively and/or additionally, the damping means could have one or more damping, spring and/or shaped elements. The damping elements could be realized, for example, as thermoplastic elastomers, elastic steel springs, gaseous, viscous and/or solid damping elements. Preferably, the damping means is separate from a counterpressure spring. Preferably, the damping means is provided to damp the recoil without a limit stop. The term “without a limit stop” in this context is to be understood to mean, in particular, that, by means of a counterpressure, the damping means itself limits a value of its compression in the damping of the recoil energy. In particular, a “counterpressure spring” is to be understood to be a spring that can be compressed by more than 10%, advantageously more than 25%, of its length by a user as a result of the insert tool being pressed onto the workpiece. Preferably, the hand power tool device has a stop that, in at least one operating state, prevents a further compression of the counterpressure spring. Preferably, the damping element has a spring hardness that is at least five times as great, preferably at least ten times as great, as the counterpressure spring. Preferably, in at least one operating state, the counterpressure spring moves a no-load control means. Advantageously, the damping means damps the recoil energy independently of a counterpressure spring and/or, in particular, parallelwise in relation to a counterpressure spring. In the case of a hand power tool device that does not have a counterpressure spring, the damping means damps the recoil energy “independently of a counterpressure spring”. “Parallelwise” in this context is to be understood to mean, in particular, that a recoil impulse caused by the recoil energy is routed, via the damping means and then via an element, in the direction of a main handle that is parallel to the counterpressure spring. The term “act” in this context is to be understood to mean, in particular, that a recoil impulse that carries the recoil energy generates a force upon the damping means that deforms the damping means. The expression “radially outside of” is to be understood to mean, in particular, that at least one region of the damping means is at a greater distance from a center axis of the hammer tube in a radial direction than an average outer surface of the hammer tube. The design of the hand power tool device according to the invention makes it possible to achieve a particularly short axial structural length and a particularly effective B-impact damping. Furthermore, a large volume that can be achieved in a structurally simple manner makes it possible to achieve a low specific loading of the damping means. Consequently, inexpensive materials can be used for damping.

In a further design, it is proposed that the damping means at least partially surrounds the hammer tube, such that a particularly advantageous utilization of structural space and advantageous cooling are possible. The term “surround” is to be understood to mean, in particular, that, in an axial extent region of the hammer tube, the damping means is disposed at least partially radially outside of the hammer tube. Advantageously, the damping means surrounds the hammer tube on an angular region of at least 270 degrees, particularly advantageously around 360 degrees.

Furthermore, it is proposed that the hand power tool device has a no-load control means that, in at least one operating state, transfers at least a part of the recoil energy, thereby making it possible to achieve a particularly effective recoil damping and to save on components. In addition, the no-load control device can be realized with a low susceptibility to vibration. In general, it is advantageous if the recoil energy is diverted to the hand power tool housing via as many components as possible. At each interface from one component to another, recoil energy is dissipated and force peaks are reduced. A “no-load control means” is to be understood to mean, in particular, a means provided to close at least one control opening of the hammer tube in at least one operating state.

Preferably, the counterpressure spring is provided to directly and/or indirectly displace the no-load control means into a no-load position. A “part of the recoil energy” is to be understood in this context to mean, in particular, the part of the recoil energy that is transferred to the hand power tool device by the damping means during operation.

Further, it is proposed that, in at least one operating state, the no-load control means supports a part of the recoil energy, in particular directly on the hammer tube and/or on a hand power tool housing, thereby enabling an advantageous transfer of the recoil energy to be achieved in a structurally simple manner. In particular, “support” is to be understood to mean that the hammer tube and/or the hand power tool housing effects a counterforce that acts contrary to a force of the recoil energy.

In addition, it is proposed that the B-impact damping system has at least two damping means connected in series, thereby making it possible to achieve a reliable damping, having an advantageous spring characteristic, in a structurally simple manner. “Connected in series” is to be understood to mean, in particular, that a part of the recoil energy acts upon a second damping means via at least one first damping means.

Furthermore, it is proposed that the B-impact damping system has at least one support element, which is disposed between the damping means, thereby making it possible to prevent unstable deformation behaviors such as, for example, turning over. A “support element” is to be understood to be, in particular, an element provided to effect a force upon the damping means in a direction that differs from the main working direction.

In an advantageous realization of the invention, it is proposed that the B-impact damping system has at least one bypass means provided to bypass at least one of the damping means. A “bypass means” is to be understood to mean, in particular, a region of a component that, in at least one operating state, effects a transfer of force functionally parallelwise in relation to the damping means. Preferably, the bypass means becomes effective from a particular compression of the damping means onwards. The bypass means makes it possible to achieve a particularly advantageous spring characteristic.

Furthermore, it is proposed that the damping means have differing damping properties. In particular, “differing damping properties” are to be understood to mean, in particular, a differing spring hardness, a differing energy absorption upon deformation and/or other properties considered appropriate by persons skilled in the art. The differing damping properties make it possible to achieve an advantageous spring characteristic, in particular having a progressive stiffness characteristic.

Further, it is proposed that the hammer tube is mounted so as to be movable relative to a hand power tool housing, thereby making it possible to achieve a hand power tool device having particularly low vibration, in particular in that the hammer tube executes compensatory motions that reduce vibration.

Further, the invention is based on a hand power tool comprising a hand power tool device, wherein all hand power tools considered appropriate by persons skilled in the art, such as, in particular, chipping hammers, screwdrivers and/or, in particular, rotary hammers, would be conceivable for operation with a hand power tool device, thereby making it possible to provide a particularly low-vibration, light, compact and inexpensive hand power tool that has a long service life and a particularly small axial structural length.

### DRAWING

Further advantages are given by the following description of the drawing. Three exemplary embodiments of the invention are represented in the drawing. The drawing, the description and the claims contain numerous features in combination. Persons skilled in the art will, expediently, also consider the features individually and combine them to form appropriate, further combinations.

In the drawing:

FIG. 1 shows a hand power tool comprising a hand power tool device according to the invention,

FIG. 2 shows a first exemplary embodiment of the hand power tool device from FIG. 1, comprising a damping means,

FIG. 3 shows a second exemplary embodiment of the hand power tool device from FIG. 1, comprising a plurality of damping means, and

FIG. 4 shows a third exemplary embodiment of the hand power tool device from FIG. 1, comprising a movably mounted hammer tube.

### DESCRIPTION OF THE EXEMPLARY EMBODIMENTS

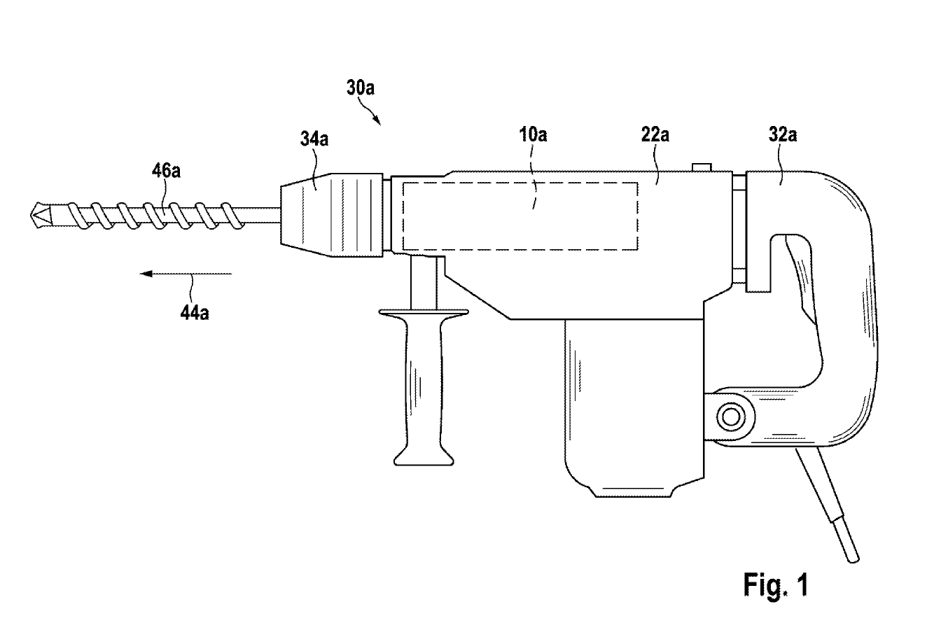

FIG. 1 shows a hand power tool 30a comprising a hand power tool device 10a according to the invention, a hand power tool housing 22a, a main handle 32a and a tool chuck 34a. The hand power tool 30a is realized as a rotary and chipping hammer. The hand power tool device 10a is disposed inside the hand power tool housing 22a, specifically between the main handle 32a and the tool chuck 34a.

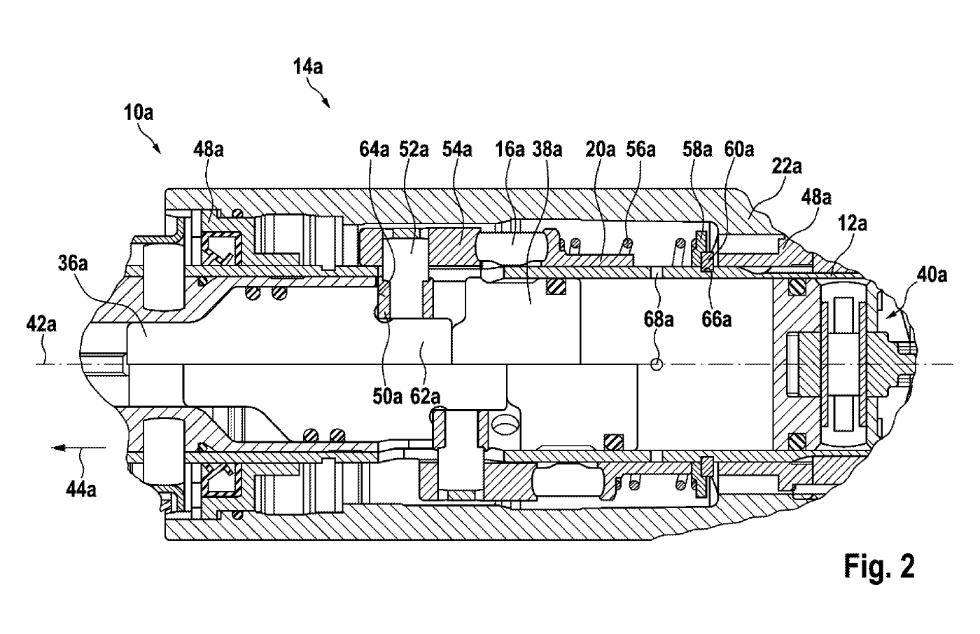

FIG. 2 shows a detail view of the hand power tool device 10a. The hand power tool device 10a has a hammer tube 12a, a B-impact damping system 14a, an impact means 36a, a striker 38a and a piston 40a. In FIG. 2, a no-load operating state is shown above the center axis 42a of the hammer tube 12a. Shown below the center axis 42a is an operating state during an impact. The striker 38a and the piston 40a are mounted so as to be movable in the hammer tube 12a. The striker 38a is disposed in front of the piston 40a in the main working direction 44a, specifically between the piston 40a and the impact means 36a. The impact means 36a is disposed between the tool chuck 34a and the striker 38a.

During impact and rotary impact operation, the piston 40a generates in the hammer tube 12a a working air pressure that differs from an ambient air pressure. The working air pressure accelerates the striker 38a. During an impact, the striker 38a delivers an impact energy to the impact means 36a. The impact means transfers the impact energy on to an insert tool 46a. During a working operation, the impact energy acts upon a workpiece, not represented in greater detail. A part of the impact energy is reflected, as recoil energy, by the workpiece. The recoil energy, via the impact means 36a, acts upon the B-impact damping system 14a. During rotary impact and rotary operation, the hammer tube 12a is driven in rotation about the center axis 42a. For this purpose, the hammer tube is mounted in the hand power tool housing 22a in a rotatable and axially fixed manner by two bearings 48a. The hammer tube 12a is connected to the tool chuck 34a in a rotationally fixed manner.

The B-impact damping system 14a has a damping means 16a, which is realized as a damping ring. The damping means 16a has an elastomer material. During operation, the damping means 16a is acted upon by the entire recoil energy, apart from a portion of the recoil energy that, through friction, is diverted between the damping means 16a and the insert tool 46a. The damping means 16a damps the recoil energy without a limit stop. This means that, through an elastic deformation, the damping means 16a effects a force that acts contrary to the recoil and that limits the deformation of the damping means 16a. In particular, no limit stop effects a force functionally parallelwise in relation to the damping means 16a. During damping, the damping means 16a undergoes only elastic deformation. The damping means 16a is disposed in its entirety radially outside of the hammer tube 12a. The damping means 16a in this case encloses the hammer tube 12a in the manner of a ring, on a plane perpendicular to the center axis 42.

In addition, the B-impact damping system 14a has a no-load control means 20a, a guide means 50a, driving pins 52a, a spacer means 54a, a counterpressure spring 56a, a support disk 58a and a retaining ring 60a. The guide means 50a surrounds a tapered region 62a of the impact means 36a. It is realized as a guide bushing. The guide means 50a is mounted on the impact means 36a so as to be movable as far as a limit stop surface 64a of the impact means 36a. The driving pins 52a are disposed in a form fit manner in recesses of the guide means 50a. The driving pins 52a extend through the hammer tube 12a. On an outer side of the hammer tube 12a, the driving pins 52a engage in the spacer means 54a. The spacer means 54a is realized as a sleeve. The spacer means 54a surrounds the hammer tube 12a.

The impact means 36a transfers a recoil energy to the guide means 50a via the limit stop surface 64a. The guide means 50a transfers the recoil energy on to the driving pins 52a. The driving pins 52a direct the recoil energy out of the hammer tube 12a. On the outside of the hammer tube 12a, the driving pins 52a transfer the recoil energy on to the spacer means 54a. The spacer means 54a transfers the recoil energy on to the damping means 16a. The damping means 16a deforms as a result of the recoil energy and, in so doing, converts a part of the recoil energy into thermal energy. The damping means 16a delivers a part of the recoil energy on to the no-load control means 20a. This part has a significantly lesser amplitude of a recoil force than the recoil energy transferred by the impact means 36a.

During an impact, the no-load control means 20a supports the damping means 16a, and thus delivers a portion of the recoil energy to the hammer tube 12a. For this purpose, the retaining ring 60a engages in a groove 66a in the hammer tube 12a. The support disk 58a is disposed between the retaining ring 60a and the no-load control means 20a. The no-load control means 20a thus transfers a part of the recoil energy to the hammer tube 12a.

The no-load control means 20a is mounted so as to be movable relative to the hammer tube 12a, for the purpose of switching the impact operation on and off. When an operator presses the insert tool 46a against the workpiece at the start of a working operation, the operator is moving the no-load control means 20a. For this purpose, the insert tool 46a displaces a part of the B-impact damping system 14a against a force of the counterpressure spring 56a, i.e. the B-impact damping system 14a apart from the support disk 58a and the retaining ring 60a. The no-load control means 20a in this case closes a control opening 68a of the hammer tube 12a. It is only when the control opening 68a is closed that the piston 40a can build up the working air pressure inside the hammer tube 12a, which working air pressure moves the striker 38a. When the operator removes the force of the insert tool 46a against the workpiece, the counterpressure spring 56a displaces the no-load control means 20a in the main working direction 44a. The no-load control means 20a thereby releases the control opening 68a.

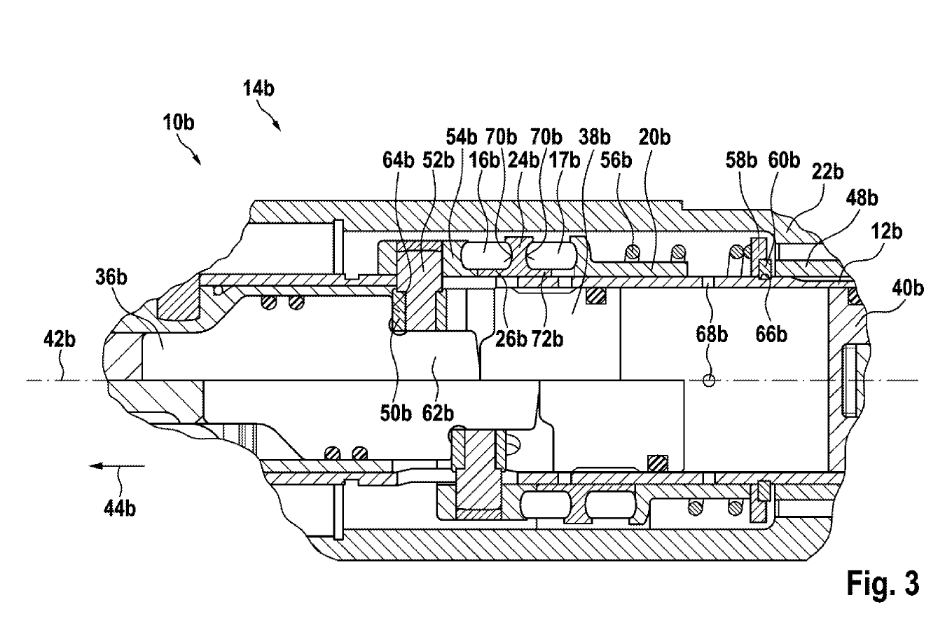

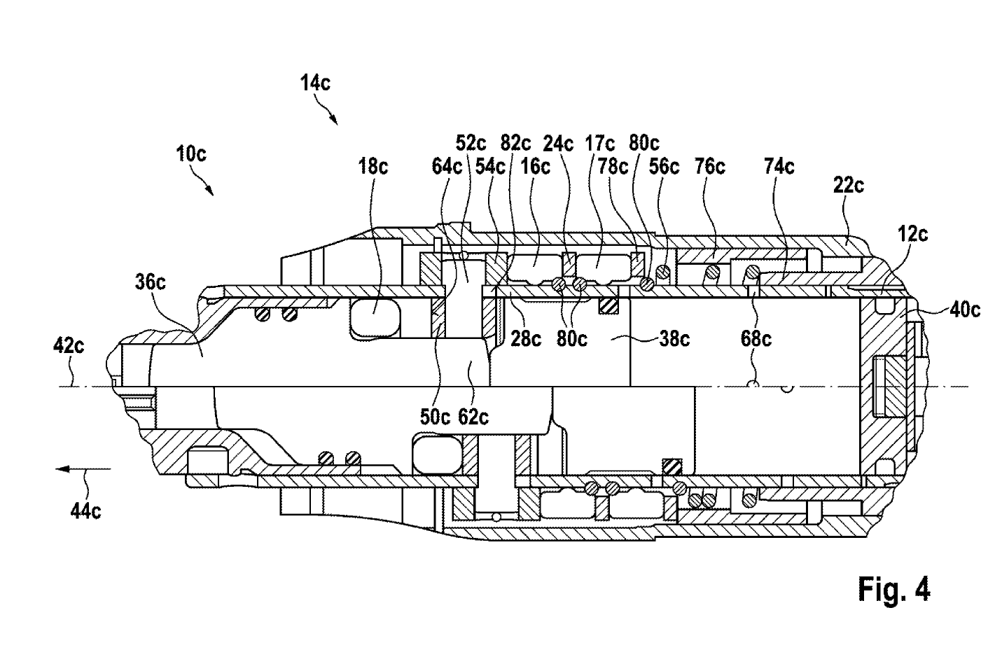

FIGS. 3 and 4 show two further exemplary embodiments of the invention. To distinguish the exemplary embodiments, the letter a in the references of the exemplary embodiments in FIGS. 1 and 2 has been replaced by the letters b and c in the references of the exemplary embodiments in FIGS. 3 and 4. The descriptions that follow are limited substantially to the differences between the exemplary embodiments and, in respect of components, features and functions that remain the same, reference may be made to the description of the other exemplary embodiments, in particular in FIGS. 1 and 2.

FIG. 3 shows a further exemplary embodiment of a hand power tool device 10b according to the invention. Like the hand power tool device from FIG. 2, the hand power tool device 10b is shown in a no-load operating state and during an impact. The hand power tool device 10b has a hammer tube 12b and a B-impact damping system 14b. The B-impact damping system 14b has two damping means 16b, 17b that are connected in series, a support element 24b and a spacer means 54b. During operation, at least 25% of a recoil energy acts upon the damping means 16b, 17b. The damping means 16b, 17b damps the recoil energy without a limit stop. The damping means 16b, 17b are disposed radially outside of the hammer tube 12b and surround the hammer tube 12b.

The support element 24b is disposed between the damping means 16b, 17b. The support element 24b surrounds the hammer tube 12b. In addition, it is mounted in an axially movable manner on the hammer tube 12b. The support element 24b has two concavely shaped support surfaces 70b, on which, respectively, there bears one of the damping means 16b, 17b. In addition, the support element 24b has a bypass means 26b. The bypass means 26b is realized as a formed-on element. The bypass means 26b extends in the axial direction along one of the damping means 16b, 17b or, more precisely, along the damping means 16b, which is disposed facing toward the spacer means 54b. When the damping means 16b is compressed by the recoil energy, a distance between the bypass means 26b and an adjacent element, in this case the spacer means 54b, is reduced. Upon a certain compression of the damping means 16b, the bypass means 26b bypasses the damping means 16b, i.e. the bypass means 26b prevents further compression of the damping means 16b.

The damping means 16b, 17b have differing damping properties. The damping means 16b that can be bypassed has a softer spring characteristic than the other damping means 17b. Furthermore, the support element 24b has a further formed-on element 72b, which has a shorter axial length than the bypass means 26b. This formed-on element prevents overloading of the damping means 16b, which is disposed facing away from the spacer means 54b.

FIG. 4 shows a further exemplary embodiment of the hand power tool device 10c according to the invention. Like the hand power tool device from FIG. 2, the hand power tool device 10c is shown in a no-load operating state and during an impact. The hand power tool device 10c has a hammer tube 12c, a B-impact damping system 14c, an impact means 36c, a control opening closure means 74c and a support means 76c. The B-impact damping system 14c has three damping means 16c, 17c, 18c connected in series, a guide means 50c, a counterpressure spring 56c and two support elements 24c, 78c. During operation, at least 25% of a recoil energy acts upon the damping means 16c, 17c, 18c.

The inner damping means 18c is disposed inside the hammer tube 12c, specifically functionally between the impact means 36c and the guide means 50c. The inner damping means 18c could thus also be integrated into the hand power tool devices of the first two exemplary embodiments. Owing to the inner damping means 18c, the other, outer damping means 16c, 17c can advantageously be small in size. The outer damping means 16c, 17c in this case have a lesser spring hardness than the inner damping means 18c. The outer damping means 16c, 17c are deformable over a greater distance than the inner damping means 18c.

The outer damping means 16c, 17c are disposed radially outside of the hammer tube 12c. One of the support elements 24c is disposed between the outer damping means 16c, 17c. The other support element 78c is disposed between the outer damping means 16c, 17c and the support means 76c. The support elements 24c, 78c are fixedly connected to the hammer tube 12c by means of retaining rings 80c. The outer damping means 16c, 17c and the support elements 24c, 78c are biased. When the operator presses a hand power tool 30c comprising the hand power tool device 10c onto a workpiece, the hammer tube 12c bears on a hand power tool housing 22c of the hand power tool 30c, via the B-impact damping system 14c.

After an impact, a part of the recoil energy from the impact means 36c acts upon the outer damping means 16c, which is the middle damping means in the axial direction, via the inner damping means 18c, a driving pin 52c and a spacer means 54c of the B-impact damping system 14c. The recoil energy compresses the middle damping means 16c until, in a recess 82c, the driving pin 52c strikes against the hammer tube 12c. The hammer tube 12c is realized partially as a bypass means 28c. Via the hammer tube 12c and the first support element 24c, a part of the impact energy acts upon the outer damping means 17c, which is the front damping means in the main working direction 44c. The support means 76c supports the front damping means 17c on the hand power tool housing 22c.

The hammer tube 12c is mounted so as to be movable relative to a hand power tool housing 22c. A control opening closure means 74c is fastened so as to be immovable relative to the hand power tool housing 22c. When an operator presses an insert tool 46c against a workpiece at the start of a working operation, the operator is moving the hammer tube 12c, i.e. moving it contrary to a main working direction 44c. For this purpose, the insert tool 46c displaces a part of the B-impact damping system 14c against a force of the counterpressure spring 56c, i.e. the B-impact damping system 14c apart from the support means 76c. The support means 76c is fixedly connected to the hand power tool housing 22c. The control opening closure means 74c in this case closes a control opening 68c of the hammer tube 12c. When the operator removes the force of the insert tool 46c against the workpiece, the counterpressure spring 56c displaces the hammer tube 12c in the main working direction 44c. The control opening closure means 74c thereby releases the control opening 68c. A control opening closure means could advantageously be realized so as to have an at least partially integral plain bearing, thereby enabling a saving to be made on a component.

1. A hand power tool device comprising:
a hammer tube, and
a B-impact damping system, the B-impact damping system including at least one damping mechanism that is configured to damp a recoil energy without a limit stop,
wherein, in at least one operating state, the damping mechanism is disposed at least partially radially outside of the hammer tube.

2. The hand power tool device as claimed in claim 1, wherein the damping mechanism at least partially surrounds the hammer tube.

3. The hand power tool device as claimed in claim 1, wherein a no-load control mechanism, in at least one operating state, transfers at least a part of the recoil energy.

4. The hand power tool device as claimed in claim 3, wherein, in at least one operating state, the no-load control mechanism supports a part of the recoil energy on one or more of the hammer tube and a hand power tool housing.

5. The hand power tool device as claimed in claim 1, wherein the B-impact damping system has at least two damping mechanisms connected in series.

6. The hand power tool device as claimed in claim 5, wherein the B-impact damping system has at least one support element disposed between the damping mechanisms.

7. The hand power tool device as claimed in claim 5, wherein the B-impact damping system has at least one bypass mechanism configured to bypass at least one of the damping mechanisms.

8. The hand power tool device as claimed in claim 5, wherein the damping mechanisms have differing damping properties.

9. The hand power tool device as claimed in claim 1, wherein the hammer tube is mounted so as to be movable relative to a hand power tool housing.

10. A hand power tool, comprising:
a hand power tool device including:
a hammer tube, and
a B-impact damping system, the B-impact damping system including at least one damping mechanism that is configured to damp a recoil energy without a limit stop,
wherein, in at least one operating state, the damping mechanism is disposed at least partially radially outside of the hammer tube.
